(19) United States
(12) Patent Application Publication
(10) Pub. No.: US 2025/0193002 A1
(43) Pub. Date: Jun. 12, 2025

(54) MANAGEMENT OF WEB3 ASSETS USING WEB2 TECHNOLOGY

(71) Applicant: SAP SE, Walldorf (DE)

(72) Inventors: Rohit Mukund DESHPANDE, Fremont, CA (US); Scott YOUNG, Palo Alto, CA (US); Narek ASADORIAN, Los Angeles, CA (US); Elias ANDREW, Seattle, WA (US); Aria NIAZI, Rocklin, CA (US)

(21) Appl. No.: 18/535,552

(22) Filed: Dec. 11, 2023

(51) Int. Cl. H04L 9/08

(52) U.S. Cl. CPC H04L 9/088

(57) ABSTRACT

Systems include reception of a request at a Web server to create a Web3 asset on a Web3 database, the request identifying metadata and data associated with the Web3 asset. In response to the received request, an identifier of the Web3 asset is stored in a database table in association with the metadata and an identifier of a tenant, the data associated with the Web3 asset is stored in a blob store, an encrypted operation is generated to create the Web3 asset on the Web3 database, where the encrypted operation encrypted by a private key associated with the identifier of the tenant, and the encrypted operation is transmitted to the Web3 database.

### BACKGROUND

Modern enterprises use computer-based systems for a multitude of tasks. For example, comprehensive enterprise resource planning applications may support most functional units of an enterprise, including but not limited to manufacturing and logistics, customer resource management, supply chain management, human resource management, and finance. Many enterprises are currently considering how Web3 assets (e.g., Non-Fungible Tokens (NFTs), tokens) may be advantageously incorporated into their processes.

The inherent characteristics of Web3 technologies are generally incompatible with an enterprise application, which usually requires fast synchronous performance and does not support transaction signing and cryptographic keys. Moreover, a typical enterprise administrator is not capable of manually generating transactions for creating and managing Web3 assets and storing those transactions on a Web3 database such as a blockchain. Even if an enterprise administrator could successfully create a Web3 asset and assign that asset to a user, the user would require an understanding of cryptographic keys, digital wallet management, Web3 database transactions, etc. in order to interact with and manage their asset. Although interfaces for interacting with Web3 databases and digital wallets exist, these interfaces are geared toward technically-adept users and can intimidate or confuse novice users.

It is therefore desirable to provide an intuitive system to create, manage, distribute and claim Web3 assets. Such a system may provide familiar interface metaphors to administrators who create and manage the Web3 assets, as well as to users who may claim assets distributed to them.

### BRIEF DESCRIPTION OF THE DRAWINGS

FIG. 1 is a block diagram of a system to manage Web3 assets using Web2 technology according to some embodiments.

FIG. 2 is a flow diagram of a process to create a custodial tenant wallet according to some embodiments.

FIG. 3 is a flow diagram of a process to generate a Web3 asset according to some embodiments.

FIG. 4 is a user interface for submitting Web authentication credentials according to some embodiments.

FIG. 5 is a user interface for specifying metadata of a Web3 asset according to some embodiments.

FIG. 6 is a user interface presenting metadata of a Web3 asset according to some embodiments.

FIG. 7 is a user interface presenting metadata for claiming a Web3 asset according to some embodiments.

FIG. 8 is a user interface for distributing a Web3 asset according to some embodiments.

FIG. 9 is a flow diagram of a process for claiming a Web3 asset according to some embodiments.

FIG. 10 is a user interface for claiming a Web3 asset according to some embodiments.

FIG. 11 is an e-mail including a link for claiming a Web3 asset according to some embodiments.

FIG. 12 is a user interface for claiming a Web3 asset according to some embodiments.

FIG. 13 is a flow diagram of a process for creating a Web3 asset on a blockchain according to some embodiments.

FIG. 14 is a flow diagram of a process for transferring a Web3 asset from a custodial tenant wallet to a user wallet according to some embodiments.

FIGS. 15a and 15b comprise user interfaces for transferring a Web3 asset from a custodial tenant wallet to a user wallet according to some embodiments.

FIGS. 16a through 16d are representations of a database table of a Web2 data store storing associations between Web3 assets, users and digital wallets according to some embodiments.

FIG. 17 is a detailed block diagram of a system to manage Web3 assets using Web2 technology according to some embodiments.

FIG. 18 comprises code of a remote signing utility according to some embodiments.

FIG. 19 is a block diagram of a system according to some embodiments.

### DETAILED DESCRIPTION

The following description is provided to enable any person in the art to make and use the described embodiments. Various modifications, however, will be readily-apparent to those in the art.

Embodiments may facilitate creation, management, and distribution of Web3 assets, such as NFTs, using Web2 technologies and backend systems. Embodiments may significantly simplify interaction with Web3 assets for both creators and consumers thereof.

Some embodiments lower administrative barriers to Web3 asset creators. A familiar and user-friendly Web2 interface enables asset creators to generate Web3 assets without understanding the intricacies of the Web3 environment or blockchain technology. Embodiments may further provide a user-friendly Web2 interface for managing users and distributing Web3 assets thereto via the users' email addresses.

As a result, a user receives an e-mail with information for claiming a Web3 asset. The user may claim ownership by selecting a link in the e-mail, thereby bypassing the technical complexities associated with claiming Web3 based assets and mitigating the need for the user to understand and navigate complex digital wallets and Web3 databases such as blockchains. According to some embodiments, a user may transfer a claimed Web3 asset to a personal wallet, enabling full Web3 ownership and interaction with the asset if desired. Embodiments may be blockchain-agnostic and provide creators the flexibility to mint Web3 assets across various blockchain platforms.

By merging familiar Web2 interfaces with Web3 functionalities, embodiments may flatten the steep learning curve often associated with blockchain technology. Embodiments may therefore be used to gradually transition users from Web2 to Web3.

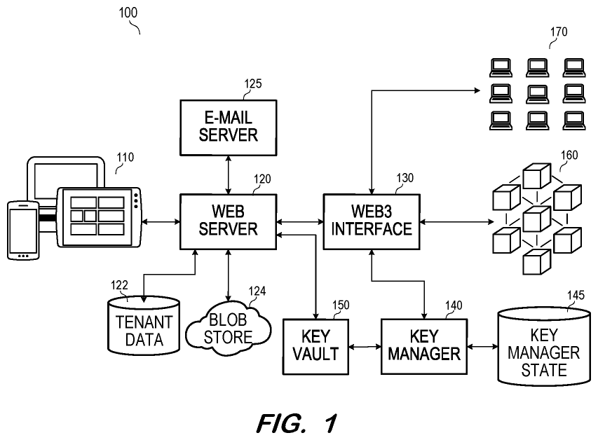

FIG. 1 is a block diagram illustrating system 100 to manage Web3 assets using Web2 technology according to some embodiments. Each of the illustrated components may be implemented using any suitable combination of computing hardware and/or software that is or becomes known. In some embodiments, two or more components are implemented by a single computing device. Two or more components of system 100 may be co-located. One or more components may be implemented as a cloud service (e.g., Software-as-a-Service, Platform-as-a-Service). A cloud-based implementation of any components of system 100 may apportion computing resources elastically according to demand, need, price, and/or any other metric.

Each component may comprise, for example, comprise a single computer server, a virtual machine, or a cluster of computer servers such as a Kubernetes cluster. Kubernetes is an open-source system for automating deployment, scaling and management of containerized applications. Each component of system 100 may therefore be implemented by one or more servers (real and/or virtual) or containers. Each data storage component depicted herein may comprise one or more storage systems, each of which may be standalone or distributed, on-premise or cloud-based.

System 100 includes user devices 110 which may be operated by administrators or users of a customer, or tenant. Each of user devices 110 may include a Web browser compatible with Web2 protocols. For example, a Web browser of a user device 110 may request and receive Web pages from Web server 120 and/or execute code of a browser application (which may or may not conform to a user interface framework loaded in the browser) to interact with a corresponding server application executed by Web server 120 to present user interfaces.

User devices 110, Web server 120 and tenant data 122 generally conform to the frontend, backend, and database paradigm of a Web2 architecture. The frontend enables user interaction and requests and receives data from the backend. The backend is a centralized server that receives requests from the frontend, fetches data from the database, and returns the response to the frontend to be displayed. All of the data is stored in the database, which is also a centralized entity.

An administrator or user may provide authentication credentials (e.g., username and password) to Web server 120 via an interface presented by a user device 110. Web server 120 executes its server application to perform an authentication process based on the credentials, receive requests from the administrator or user, and provide tenant data 122 in response to the requests and based on data authorizations granted to the administrator or user. The server application may provide any functionality that is or becomes known, including but not limited to the enterprise resource planning functionalities noted above.

According to some embodiments, an administrator interacts with Web server 120 using interfaces presented on a Web client of a user device 110 to create metadata describing a Web3 asset. The administrator may also specify data associated with the Web3 asset. For example, an administrator may define a name and attributes of an NFT and an image file associated with the NFT. Web server 120 may store the metadata and data of the NFT in association with an identifier of the NFT and a wallet identifier in tenant data 122.

The administrator may further interact with Web server 120 to specify e-mail addresses of users to whom the NFT should be distributed. Accordingly, also stored in tenant data 122 may be a list of e-mail addresses to which the NFT was distributed.

A user may receive such an e-mail via their e-mail client application and access Web server 120 using a link provided in the e-mail. The user then interacts with Web server 120 using interfaces presented on a Web client of a user device 110 to claim the NFT. As a result, an identifier of the user is stored in tenant data 122 in association with the identifier of the NFT to indicate that the user “owns” the NFT.

Blob store 124 may be cloud-based and may provide storage at a lower cost than comparable file-based storage systems. Web server 120 may store unstructured data such as NFT images in blob store 124. Accordingly, if a user requests to view the data and metadata of an NFT which they own, Web server 120 may retrieve the corresponding metadata data from tenant data 122 and the data image from blob store 124 and present it to the user without accessing Web3 storage. Accesses to tenant data 122 and blob store 124 using Web2 protocols are typically much faster and reliable than accesses to Web3 storage due in part to the asynchronous nature of Web3 protocols.

Web server 120 may also use e-mail server 125 to transmit e-mails to intended recipients as mentioned above. The e-mails may include a link which may be selected to authenticate a user directly to Web server 120 to claim a Web3 asset. E-mail server 125 may be provided by a party different from a provider of Web server 120 and Web3 interface 130.

Web server 120 may request generation of a cryptographic keypair (e.g., a public key and a private key) from key vault 150. Key vault 150 generates the keypair, stores the keypair and returns an identifier of the keypair (e.g., a wallet identifier) to Web server 120. The wallet identifier may comprise the public key of the keypair in some embodiments. Web server 120 may store the wallet identifier in tenant data 122.

The request to generate a keypair may be issued in response to a request received by Web server 120 to create a tenant. A tenant may represent a customer organization, and employees of the organization may be considered users of the tenant. Accordingly, Web server 120 may store the returned identifier of the keypair in association with an identifier of the tenant. In some embodiments, an application executed by Web server 120 may comprise a multi-tenant application, in which case Web server 120 may request generation of a respective keypair for each of several tenants. Web server 120 stores a returned identifier of each generated keypair in association with an identifier of its respective tenant.

Key vault 150 may be provided by an entity different from another one or more entities operating the other components of system 100. Advantageously, the other entities are unable to access the private keys of the keypairs generated by key vault 150. Rather, key vault 150 may only be requested to sign a transaction on behalf of a tenant using its private key and to provide the signed transaction in return.

For example, Web server 120 generates an RPC call specifying an operation (e.g., a transaction) on a Web3 database (e.g., a blockchain) and transmits the RPC call and a custodial tenant wallet identifier identifying a cryptographic keypair to Web3 interface 130. Web3 interface 130 provides the transaction and the wallet identifier to key manager 140. Key manager 140 then requests key vault 150 to sign (i.e., encrypt) the transaction using the private key associated with the wallet identifier. Key manager state information 145 may associate wallet identifiers with addresses of primary keys within key vault 150 and may therefore be used to facilitate the request to key vault 150.

Key vault 150 signs the transaction with a private key associated with the wallet identifier (e.g., using the secp256k1 elliptic curve scheme and the ECDSA signing algorithm), and returns the signed transaction to key manager 140. Web3 interface 130 submits the signed transaction to blockchain 160 by executing a predetermined JSON RPC call which corresponds to the RPC call received from Web server 120. Key manager 140 may transform the transaction prior to providing the transaction to key vault 150 so that the resulting signed transaction received from key vault 150 conforms to a format acceptable to blockchain 160.

According to some embodiments, the signed transaction generated by Web3 interface 130 may comprise a transaction to create a collection on a blockchain, to create an asset of a collection on the blockchain, to transfer an asset from one digital wallet to another digital wallet, to add attribute values to an asset, etc. For example, Web3 interface 130 receives metadata and data of an administrator-defined Web3 asset from Web server 120 and generates and transmits a signed blockchain transaction to blockchain 160 to mint the asset on blockchain 160. Moreover, Web3 interface 130 executes Web3 protocols to transmit the metadata and data to decentralized storage 170. Web3 interface may also operate per instructions from Web server 120 to generate and transmit signed blockchain transactions to blockchain 160 to transfer ownership of an asset from a custodial tenant wallet to a user wallet.

According to Web3 architecture, each block on a blockchain is composed of transactions. Before a transaction can be included in a block, it must be executed by a virtual machine associated with the block chain, such as the Ethereum Virtual Machine (EVM). The EVM runs on top of the blockchain to execute transactions between users and smart contracts and compute the new state resulting from those interactions. The newly-computed state becomes the base for a new block.

Smart contracts are programs that contain logic written in specifically-purposed languages. The code and variables of a smart contract are deployed and stored on the blockchain. A smart contract deployed to the blockchain is uniquely identified and accessed by its address. An address can identify a smart contract or an externally-owned account. Externally-owned accounts are controlled by users and smart contracts are controlled by code, although both can hold balances and interact with smart contracts.

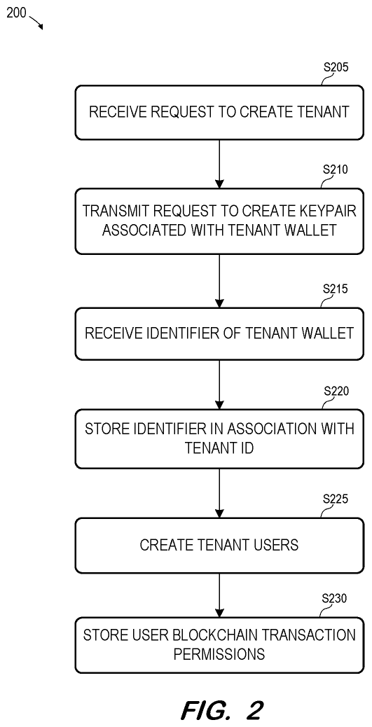

FIG. 2 comprises a flow diagram of process 200 to create a custodial tenant wallet according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any one or more processing units, including but not limited to a microprocessor, a microprocessor core, and a microprocessor thread. Embodiments are not limited to the examples described below.

Initially, at S205, a request is received to create an application tenant. The request may be received, for example, by a Web2 server such as Web server 120 from a Web browser executing on a user device such as user devices 110. According to some examples, an administrator operates a Web browser of a user device to access a Uniform Resource Locator associated with an application executed by Web server 120 and to subsequently interact with the application to request creation of a tenant as is known in the art.

Assuming the administrator is authenticated to the application and authorized to create a tenant, a request is transmitted at S210 to create a keypair associated with a wallet of the tenant. The request may be transmitted to a key vault from which the provider of the application is not permitted and is unable to retrieve private keys. The key vault generates a keypair associated with the wallet and returns an identifier of the wallet at S215. As noted above, the identifier of the wallet may comprise the public key of the keypair.

The wallet identifier is stored in association with an identifier of the new tenant at S220. For example, Web server 120 may store a record including the wallet identifier and the tenant identifier in tenant data 122. S225 may include creating users associated with the tenant by defining user identifiers and corresponding authentication credentials. Flow continues to S230 to store blockchain transaction permissions for respective users of the tenant. For example, user identifiers may be stored at S230 in association with data specifying the types of blockchain transactions which the respective users are permitted to perform.

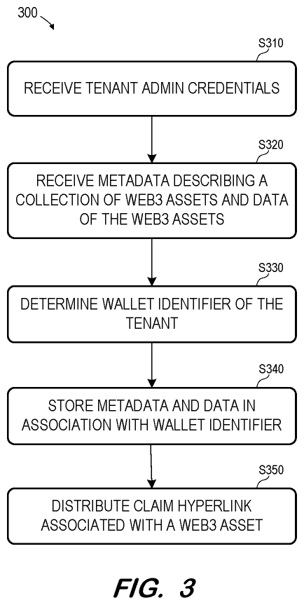

FIG. 3 is a flow diagram of a process to generate a Web3 asset according to some embodiments. Advantageously, a Web3 asset may be generated without requiring the creator to be familiar with blockchain technology.

Credentials of a tenant administrator are received at S310. For example, an administrator may operate a Web browser to access a Uniform Resource Locator associated with digital asset management functionality of an application executed by a Web server as is known in the art.

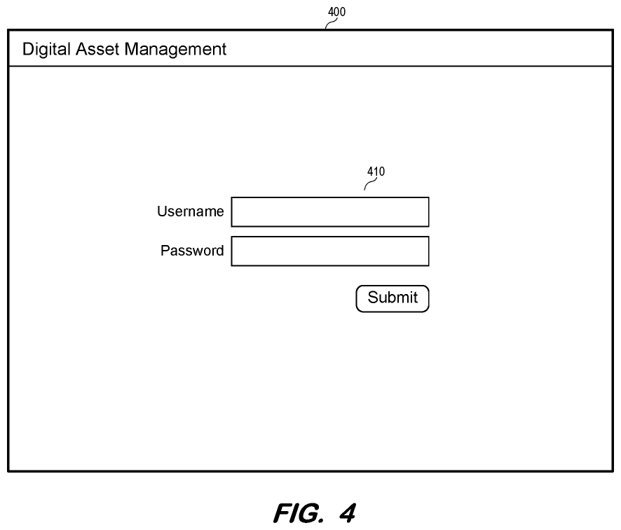

FIG. 4 illustrates user interface 400 which may be presented to the administrator as a result. User interface 400 includes input fields for receiving login credentials (i.e., username and password) 410 at S310. Authentication may proceed according to any suitable procedure, including looking up the login credentials in a database table of credentials, and multi-factor authentication. Assuming authentication is successful, flow proceeds to S320 to receive metadata describing a collection of Web3 assets and data of the Web3 assets.

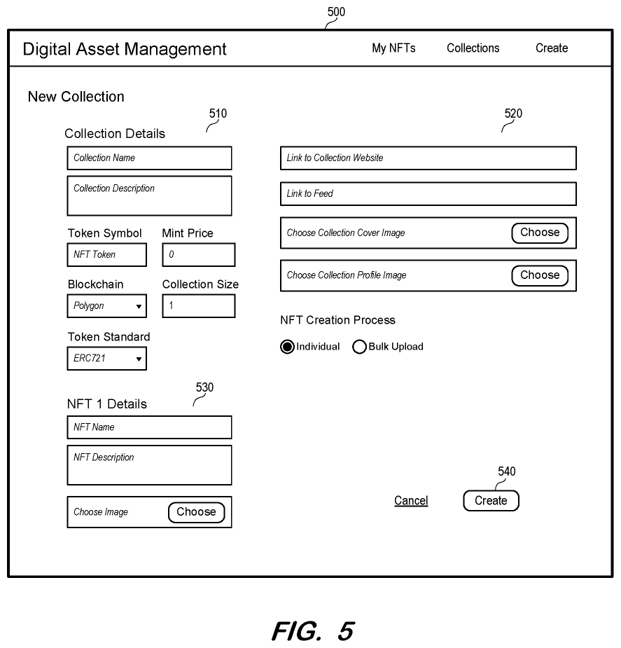

FIG. 5 illustrates interface 500 of a Web2 application to receive metadata and data describing a collection from an administrator at S320 according to some embodiments. The present example describes the creation of NFTs within collections as is known in the art. Embodiments are not limited to this paradigm. Rather, an administrator may create a Web3 asset independent of any collection if allowed by the blockchain on which the Web3 asset is to be created.

Collection details input area 510 of interface 500 allows the administrator to provide metadata of a collection to be created, including descriptive information and technical details (e.g., blockchain, Token standard) to which the collection is to conform. Input area 520 accepts hyperlinks and image data associated with the collection. NFT details input area 530 includes fields for providing a name and a description of an NFT of the collection and data (i.e., image data) associated with the NFT. Selection of Create control 540 causes submission of data input into interface 500 for reception at S320.

A wallet identifier associated with the current tenant is determined at S330. The wallet identifier may be stored by the Web2 application during creation of a keypair corresponding to the tenant as described above. The metadata and data received at S320 are stored in association with the wallet identifier at S340. For example, Web server 120 may create a record in a table of tenant data 122 associating the wallet identifier with the metadata of the collection and of its NFTs. The record may include an identifier of the tenant or any other suitable information. Web server 120 may store the data (e.g., the image data) received at S320 in blob store 124 according to some embodiments. The above-mentioned record of tenant data 122 may further include object identifiers of the stored data in blob store 124 to facilitate retrieval thereof.

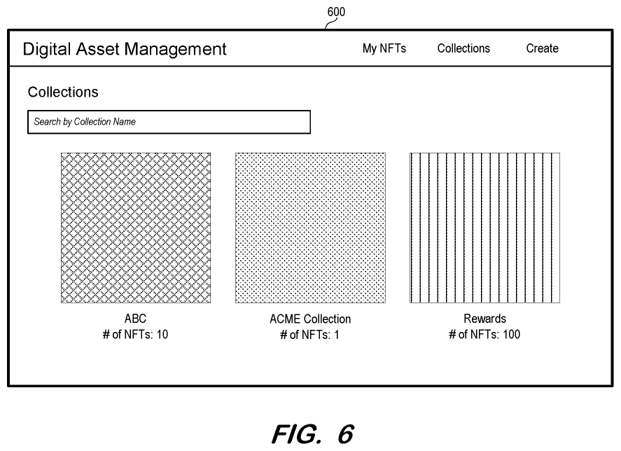

User interface 600 of FIG. 6 may be presented to the administrator based on metadata and stored by the Web2 backend. In particular, tenant data 122 may store metadata of the three collections presented by user interface 600 in association with an identifier of the current tenant. The tenant identifier is used to retrieve the metadata as well as the associated image data from blob store 124.

For example, it is assumed that the administrator selects collection “ABC” from interface 600. Interface 700 is presented in response, including the retrieved metadata and image data 710 associated with the selected collection. Manage tab 720 of interface 700 is selected, which allows the administrator to specify text to be presented on a Web interface for users to whom an NFT is distributed. Manage tab 720 also includes a link and a QR code for accessing the Web interface.

The administrator may further interact with Web server 120 to distribute a hyperlink associated with the collection at S350. FIG. 8 shows interface 700 after selection of Distribute tab 820. Distribute tab 820 includes controls for specifying one or more users and their associated email addresses. Actions control 830 may be operated to select an NFT of the collection to offer to a specified user. In the present example, NFT #6 of the ABC collection has been associated with the specified user.

Selection of Save control 840 causes e-mailing of a hyperlink to each specified user for claiming the NFT associated with the user. Web server 120 may utilize e-mail server 125 to send the e-mail at S350. The hyperlink may comprise the links shown in Manage tab 720 and may be accompanied by the text shown therein. Tenant data 122 may also be updated to associate the metadata of each distributed NFT with an identifier of the user to whom the NFT was distributed. This association may be subsequently used to determine whether a user attempting to claim an NFT is the same user to whom the NFT was distributed (i.e., to whom the hyperlink was e-mailed).

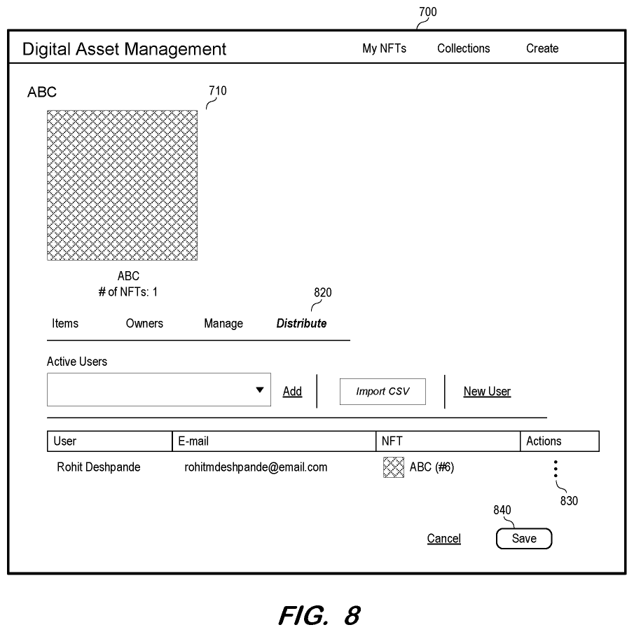

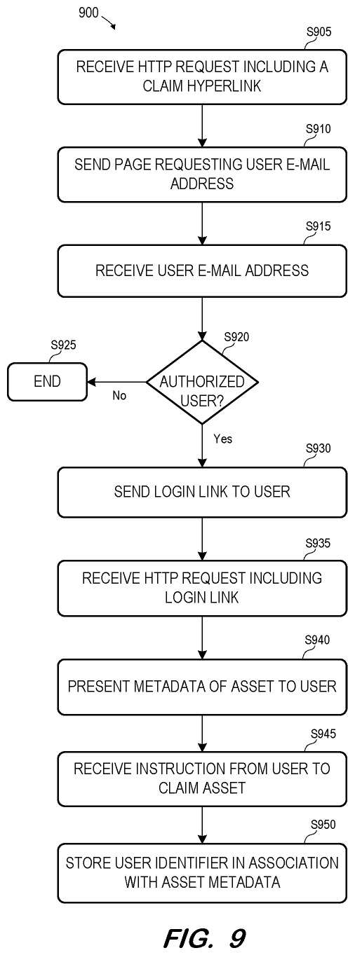

FIG. 9 is a flow diagram of process 900 for claiming a Web3 asset according to some embodiments. Prior to process 900, a user initiates an HTTP request including a hyperlink for claiming a Web3 asset. The hyperlink may be transmitted to the user via an e-mail as described above. In some embodiments, the user scans a QR code (i.e., which is publicly available or otherwise directed to the user) including the hyperlink to initiate the HTTP request. The HTTP request is received (e.g., by Web server 120) at S905.

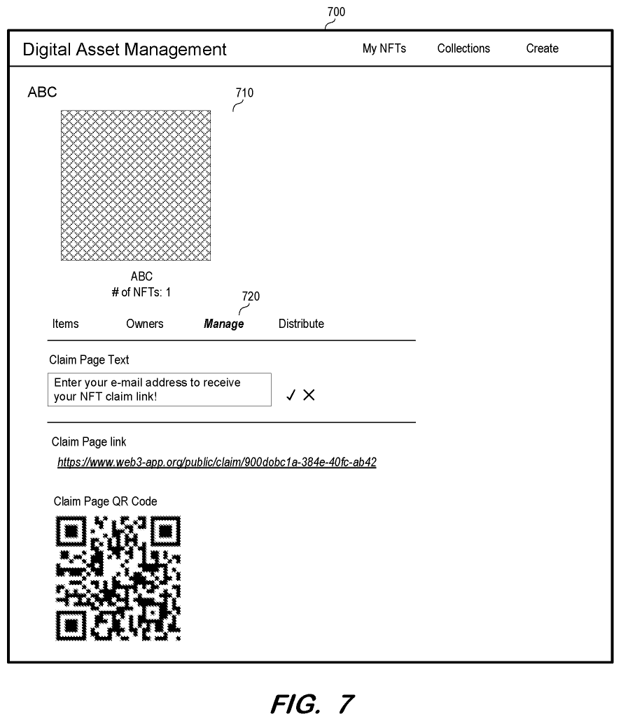

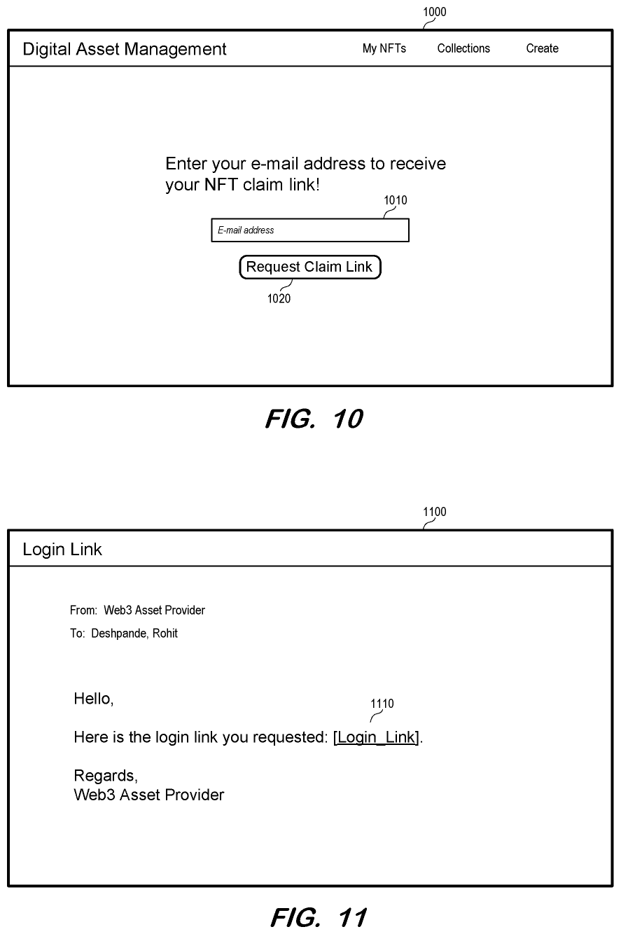

A Web page or other interface is sent to the user at S910 in response to the HTTP request. The Web page includes a request for the user's e-mail address. FIG. 10 illustrates Web page 1000 sent at S910 and presented by a Web browser of a user device. Web page 1000 includes the text specified in the Manage tab 720 of FIG. 7 and input field 1010 for receiving the user's e-mail address. The user submits their e-mail address into field 1010 and selects control 1020.

The user e-mail is received at S915. At S920, it is determined whether the user is an authorized user of the tenant. The authorization may comprise any authorization method that is or becomes known, including checking the received e-mail address against a list of authorized e-mail addresses. Flow terminates at S925 if the user is not an authorized user.

If the user is authorized, an e-mail including a login link is sent at S930 to the e-mail address received at S915. In the case of system 100, Web server 120 may use e-mail server 125 to send the e-mail. The login link may comprise a “magic” link which facilitates passwordless authentication to the asset-claiming functionality of a Web2 server. The login link may identify the user and also identify the Web3 asset to be claimed by the user.

FIG. 11 illustrates e-mail 1100 which may be sent at S930 in some embodiments. E-mail 1100 includes selectable login link 1110. User selection of link 1110 causes reception of an HTTP request including the link at S935. Metadata of an asset is presented to the user in response to the HTTP request at S940.

According to some embodiments of S940, the Web3 asset identified by the login link of the received HTTP request is determined. Next, a check may be performed to confirm that the Web3 asset is associated (e.g., within tenant data 122) with the user identified in the login link.

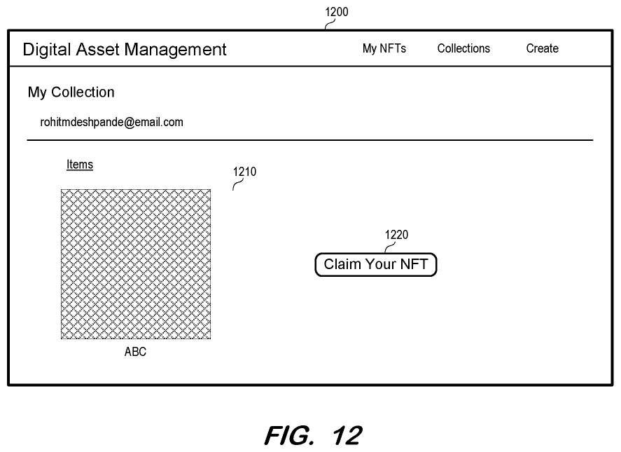

FIG. 12 illustrates interface 1200 which may be presented at S940. Interface 1200 includes metadata “ABC” and image 1210 of the NFT to be claimed. The metadata and image data may be retrieved from tenant data 122 and blob storage 124 based on an identifier of the NFT. Interface 1200 also includes control 1220 which the user may select to transmit an instruction to claim the asset. The instruction is received at S945.

In response to the instruction, an identifier of the user is stored in association with the stored metadata of the asset at S950. Storage of this association in tenant data 122, for example, allows Web server 120 to determine that the user has claimed the Web3 asset without requiring a query of the blockchain. Accordingly, the user may log in to Web server 120 in the future to view the metadata and data of their claimed Web3 assets without initiating any Web3 procedures.

Process 300 and process 900 have described above as implemented using Web2 technology alone. The following describes a system to integrate, in a mutually consistent manner, such Web2 processes with the creation (i.e., minting) and management of a Web3 asset (e.g., a collection and its NFTs) on a blockchain.

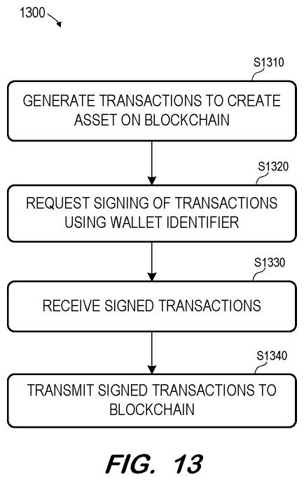

FIG. 13 is a flow diagram of a process for creating a Web3 asset on a blockchain according to some embodiments. It will be assumed that metadata and data of an asset has been defined and stored in tenant data 122 and blob storage 124 as described above. Asynchronous to such storage, and based on any suitable trigger (e.g., time-based, batch-based) one or more transactions to create the asset on a specified blockchain are generated at S1310.

In the present example, the one or more transactions may comprise an interaction with a factory smart contract for creating a collection that causes cloning of the factory smart contract on the blockchain, and a transaction to associate an identifier of an NFT with the collection. In some embodiments of S1310, Web server 120 generates a HyperText Transfer Protocol (HTTP) RPC call for each transaction which specifies the transaction and includes the custodial tenant wallet identifier.

The call is transmitted to Web3 interface 130, which transmits a request to key vault 150 at S1320 to sign the transactions using the private key associated with the wallet identifier. The key vault signs the transactions with the private key and returns the signed transactions for receipt at S1330. The signed transactions are then transmitted to the blockchain at S1340 by, for example, transmitting JSON RPC calls which correspond to the HTTP RPC calls to a blockchain node.

Some embodiments of process 1300 further include storage of the metadata and data of the NFT on a Web3 decentralized storage system such as InterPlanetary File System (IPFS). For example, Web3 interface 130 may pull the metadata and data from tenant data 122 and blob storage 124 after receiving a gRPC call from Web server 120 and then save the metadata and data to IPFS via a data layer such as but not limited to web3.storage. Identifiers of the saved metadata and data within IPFS may be returned to Web server 120 and associated with the NFT record in tenant data 122. Moreover, Web3 interface 130 may generate and transmit a signed transaction to associate the IPFS identifiers of the saved metadata and data with the NFT on the blockchain.

It should be noted that process 900 may proceed to allow user claiming of an asset and viewing the metadata and data of the asset via Web2 technology regardless of the status of the creation of the asset on the blockchain via process 1300. In some embodiments, tenant data 122 is updated to indicate that an asset has been minted on the blockchain once confirmation thereof is received.

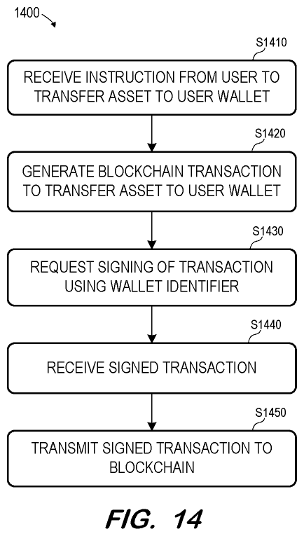

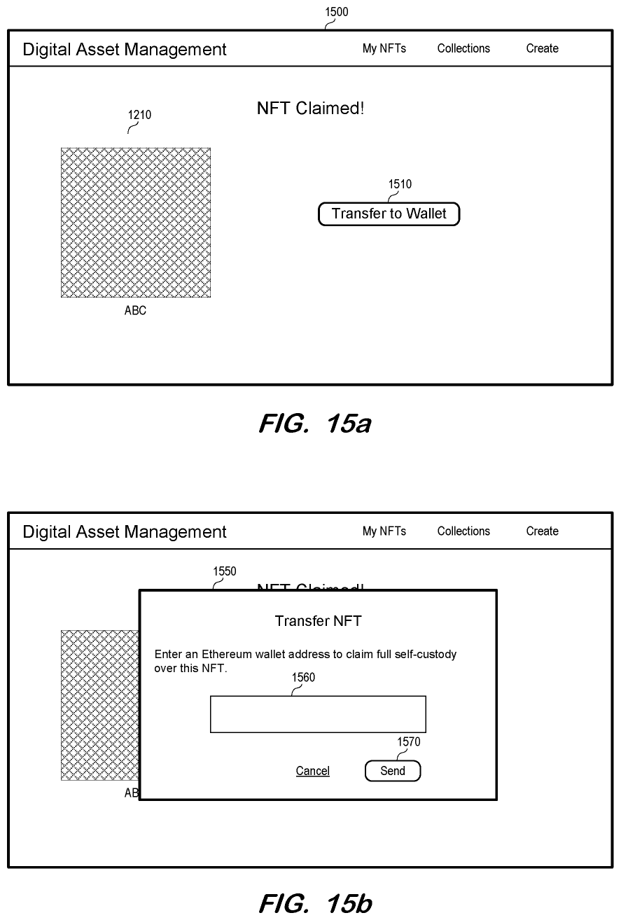

FIG. 14 is a flow diagram of process 1400 for transferring a Web3 asset from a custodial tenant wallet to a user wallet according to some embodiments. Returning to FIG. 12, it is assumed that the user selects control 1220 of interface 1200 to transmit an instruction to claim the asset. In response, interface 1500 of FIG. 15a is presented. Interface 1500 indicates that the NFT has been claimed by the user (e.g., associated with the user's identify in tenant data 122) and provides control 1510 for transferring the NFT to a digital wallet of the user.

Selection of control 1510 results in display of pop-up window 1550 of FIG. 15b. Pop-up window 1550 includes input field 1560 to receive an identifier of the user's digital wallet. The identifier may comprise a wallet address, which is a string of characters representing a hashed version of the public key of the wallet. The user inputs the wallet identifier into field 1560 and selects Send control 1570 to transmit an instruction to transfer the NFT to the user's digital wallet. The instruction is received at S1410 of process 1400.

Next, a blockchain transaction is generated at S1420 to transfer the asset from the custodial tenant wallet to the user's digital wallet. Generation of a blockchain transaction to transfer an asset between digital wallets is known in the art. For example, the transaction may interact with a smart contract associated with a collection including the asset. At S1430, Web3 interface 130 transmits a request to key vault 150 to sign the transaction using the private key associated with the custodial tenant wallet identifier. Key vault 150 signs the transaction and returns the signed transaction for receipt at S1440. The signed transaction is then transmitted to the blockchain at S1450. In some embodiments, a confirmation of the transfer is presented to the user once the blockchain has confirmed the transaction.

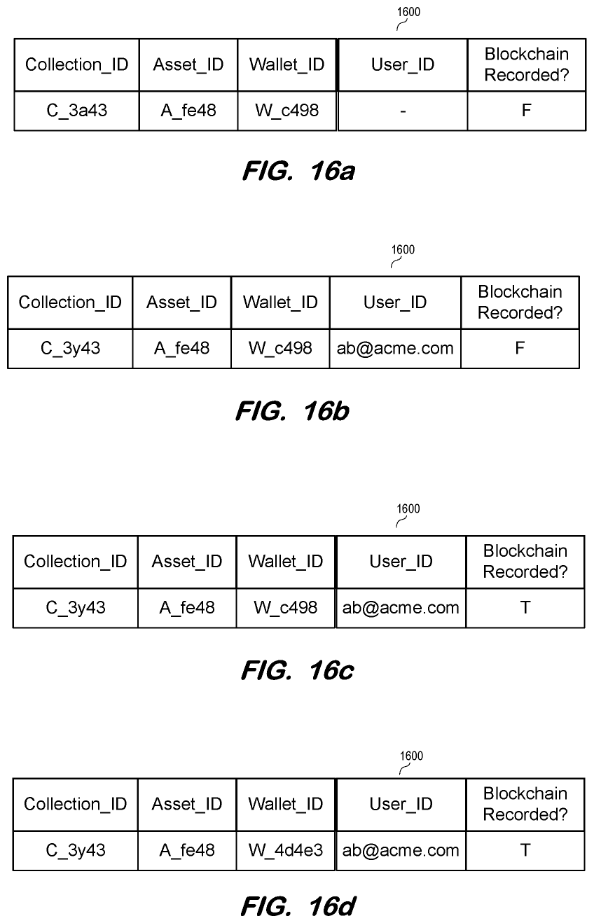

FIGS. 16a through 16d are representations of a database table of a Web2 data store storing associations between Web3 assets, users and digital wallets according to some embodiments. With reference to the above description, table 1600 may be stored in tenant data 122 and updated by Web server 120 in response to creation, claiming and transfer of Web3 assets. Embodiments are not limited to table 1600 or to the foregoing description of usage thereof.

FIG. 16a shows a record of table 1600 after creation of an asset by an administrator as described above with respect to S310 through S340 of process 300. The record includes a collection identifier, an asset identifier, and an identifier of the custodial tenant wallet. The asset has not yet been distributed to a user nor minted on the blockchain, so the user identifier field of the record is empty and the “blockchain recorded?” flag of the record is set to False.

FIG. 16b shows the record of table 1600 after the asset has been claimed by a user as described with respect to process 900. The record now includes an identifier (i.e., an e-mail address) of the claiming user. In the present example, the asset has not yet been recorded to the blockchain, and therefore the “blockchain recorded?” flag of the record remains set to False.

FIG. 16c shows the record of table 1600 after the asset has been recorded to the blockchain, with the “blockchain recorded?” flag of the record set to True. It should be noted that the asset may be recorded to the blockchain prior to distribution to a user or claiming by a user, in which case the user identifier field of the record is empty and the “blockchain recorded?” flag of the record is set to True.

FIG. 16d illustrates the record of FIG. 16c after transfer of the associated asset from the custodial tenant wallet to a wallet of the user. Accordingly, the wallet identifier of the record has been changed from “W_c498” to “W_4d4e3”. In some embodiments, the wallet identifier of the record is changed only after confirmation of a transaction which transfers the asset on the blockchain.

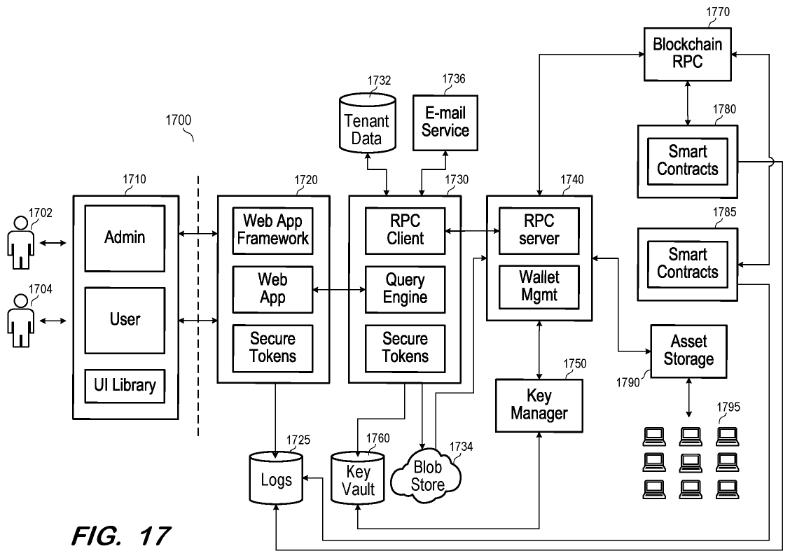

FIG. 17 is a detailed block diagram of system 1700 to manage Web3 assets using Web2 technology according to some embodiments. System 1700 may comprise an implementation of system 100 according to some embodiments. System 1700 includes client 1710 which executes within a user device, client server 1720, API layer 1730 and Web3 interface 1740. In some embodiments, client server 1720, API layer 1730 and Web3 interface 1740 are deployed as Docker containers using Kubernetes. Client server 1720, API layer 1730 and Web3 interface 1740, as well as key manager 1750, may be deployed in the same on-premise backend.

Client 1710 may comprise a single page application using a UI library such as React, for example. The single page application may support an administrator experience for administrator 1702 and a user experience for user 1704. Client 1710 may be served by a Web application of client server 1720 built on a Web application framework such as Next.js. The Web application of client server 1720 or the single page application of client 1710 may communicate with API layer 1730 via an API query language such as GraphQL and leverages secure tokens (e.g., Web tokens) for user authentication, user authorization, and multi-tenancy.

API layer 1730 supports client experiences with a traditional Web2 data source, while also passing through and staying in sync with Web3 data through Web3 interface 1740. API layer 1730 may comprise a traditional Software-as-a-Service application providing user and account management, Web2 data models and data storage, and multitenancy support. API layer 1730 allows access through the secure tokens (e.g., PASETO tokens, JSON Web Tokens), saves transactional data into tenant data 1732 and blob storage 1734, sends outgoing e-mails via e-mail service 1736 (e.g., SendGrid) and runs an RPC (e.g., gRPC) client to communicate with Web3 interface 1740. The secure tokens store information regarding the user, the tenant, and the user's role. All queries may be authenticated and authorized using the token information rather than API arguments.

Web3 interface 1740 is a stateless service that handles interactions with blockchains 1780 and 1785. For example, Web3 interface 1740 may transmit signed transactions to blockchains 1780 and 1785. The transactions may, for example, create an asset, transfer an asset, create a smart contract, or interact with a smart contract. In the latter regard, Web3 interface 1740 provides transactions needed to execute the functionality of the created smart contracts so that API layer 1730 can call that functionality via Web3 interface 1740.

Web3 interface 1740 may communicate with blockchains 1780 and 1785 via blockchain RPC 1770. Embodiments are not limited to two blockchains. Blockchain RPC 1770 may be provided by a 3rd party (e.g., Alchemy) but embodiments are not limited thereto. Web3 interface 1740 may comprise a Rust server which communicates with API layer 1730 through gRPC, where Protocol Buffers define the API contracts between Web3 interface 1740 and API layer 1730.

Web3 interface 1740 communicates with asset storage layer 1790 to store metadata and data of Web3 assets in decentralized storage 1795. Decentralized storage may comprise IPFS, and layer 1790 may comprise web3.storage in some embodiments.

Web3 interface 1740 provides management of tenant (i.e., custodial tenant) and user wallets. Wallet management includes wallet creation, funds transfer, and other functionalities. Wallet management also includes orchestration of blockchain transaction signing using a private key associated with a wallet. Web3 interface 1740 communicates with key manager 1750 to perform such signing. Key manager 1750 may comprise a trusted open-source key management solution such as Consensys Quorum Key Manager but embodiments are not limited thereto.

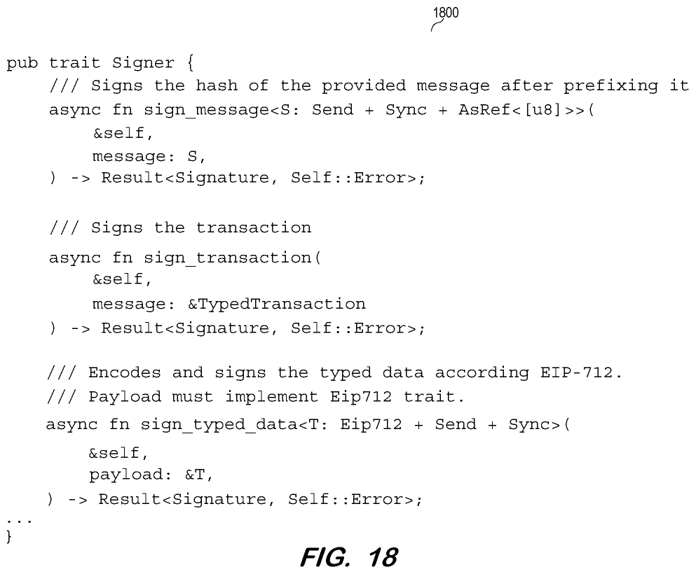

Key manager 1750 may implement a remote signing utility which is called by Web3 interface 1740 to request signing of a transaction. FIG. 18 is an example of code 1800 of a remote signing utility of key manager 1750 using the ethers-signer trait according to some embodiments. Key manager 1750 may in turn request signing of a transaction using a private key stored in key vault 1760.

A clone factory contract (e.g., EIP-1167) for each smart contract to be used may be deployed on blockchains 1780 and 1785. A clone factory contract is called by Web3 interface 1740 to clone new smart contracts on its blockchain. The clone factory contracts may leverage open-source libraries (e.g., OpenZeppelin) and may comprise Solidity smart contracts in the case of the Ethereum blockchain.

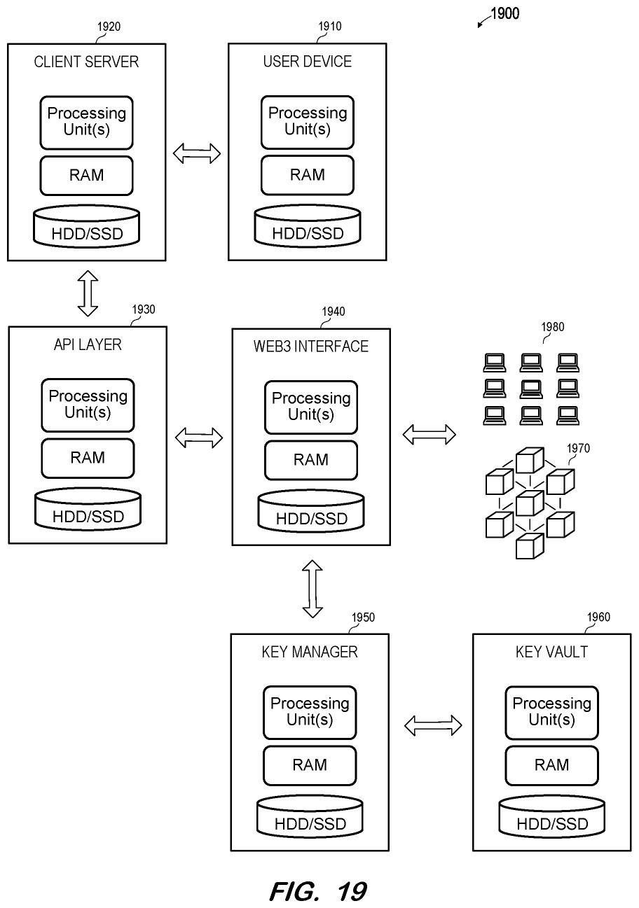

FIG. 19 is a block diagram of cloud-based architecture 1900 according to some embodiments. Client server 1920, API layer 1930, Web3 interface 1940, and key manager 1950 may comprise cloud-based compute resources, such as one or more virtual machines, allocated by a public cloud provider providing self-service and immediate provisioning, autoscaling, security, compliance and identity management features. Client server 1920, API layer 1930, Web3 interface 1940, and key manager 1950 may execute containerized applications deployed in Docker containers on Kubernetes. A user may operate user device 1910 to interact with client server 1920 via a Web2 paradigm. The remaining components of architecture 1900, including key vault 1960, may operate as described above to transmit transactions to blockchain 1970 and store metadata and data of Web3 assets in decentralized storage 1980.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing executable program code; and
at least one processing unit to execute the program code to cause the system to:
receive a request at a Web server to create a Web3 asset on a Web3 database, the Web3 asset associated with metadata and data; and
in response to the received request:
store an identifier of the Web3 asset in association with the metadata and a second identifier;
store the data associated with the Web3 asset in a blob store;
generate an encrypted operation to create the Web3 asset on the Web3 database, the encrypted operation encrypted by a private key associated with the second identifier;
transmit the encrypted operation to the Web3 database; and
transmit the data and the metadata to a Web3 decentralized storage system.

2. The system according to claim 1, the at least one processing unit to execute the program code to cause the system to:
receive a second request from a user at the Web server to claim the Web3 asset; and
in response to the second request, store an identifier of the user in association with the identifier of the Web3 asset, the metadata and the second identifier.

3. The system according to claim 2, the at least one processing unit to execute the program code to cause the system to:
receive a third request from the user at the Web server to view the Web3 asset; and
in response to the third request:
retrieve the stored metadata of the Web3 asset based on the identifier of the Web3 asset;
determine a location of the data of the Web3 asset in the blob store based on the identifier of the Web3 asset;
retrieve the data of the Web3 asset from the determined location in the blob store; and
present the data and the metadata of the Web3 asset to the user.

4. The system according to claim 2, the at least one processing unit to execute the program code to cause the system to:
receive an instruction from the user at the Web server to transfer the Web3 asset to a third identifier; and
in response to the instruction:
store the third identifier in association with the identifier of the user, the identifier of the Web3 asset and the metadata;
generate a second encrypted operation to transfer the Web3 asset to the third identifier, the second encrypted operation encrypted by the private key associated with the second identifier; and
transmit the second encrypted operation to the Web3 database.

5. The system according to claim 1, the at least one processing unit to execute the program code to cause the system to:
receive an instruction from a user at the Web server to transfer the Web3 asset to a third identifier; and
in response to the instruction:
store the third identifier in association with the identifier of the Web3 asset and the metadata;
generate a second encrypted operation to transfer the Web3 asset to the second identifier, the second encrypted operation encrypted by the private key associated with the second identifier; and
transmit the second signed operation to the Web3 database.

6. The system according to claim 1, the at least one processing unit to execute the program code to cause the system to:
receive an instruction at the Web server to assign the Web3 asset to a user; and
in response to the instruction, store an identifier of the user in association with the identifier of the Web3 asset, the metadata and the second identifier.

7. The system according to claim 6, the at least one processing unit to execute the program code to cause the system to:
transmit from the Web server an e-mail to the user including a link associated with the Web3 asset;
receive an HTTP request from the user including the link; and
in response to the HTTP request:
retrieve the stored metadata of the Web3 asset based on the link;
retrieve the data of the Web3 asset from the blob store; and
present the data and the metadata of the Web3 asset to the user.

8. A method comprising:
receiving a request at a Web server to create a Web3 asset on a Web3 database, the request identifying metadata and data associated with the Web3 asset; and
in response to the received request:
storing an identifier of the Web3 asset in a database table in association with the metadata and an identifier of a tenant;
storing the data associated with the Web3 asset in a blob store;
generating an encrypted operation to create the Web3 asset on the Web3 database, the encrypted operation encrypted by a private key associated with the identifier of the tenant; and
transmitting the encrypted operation to the Web3 database.

9. The method according to claim 8, further comprising:
receiving a second request from a user at the Web server to claim the Web3 asset; and
in response to the second request, storing an identifier of the user in association with the stored identifier of the Web3 asset, metadata and the identifier of the tenant.

10. The method according to claim 9, further comprising:
receiving a third request from the user at the Web server to view the Web3 asset; and
in response to the third request:
retrieving the stored metadata of the Web3 asset based on the identifier of the Web3 asset;
determining a location of the data of the Web3 asset in the blob store based on the identifier of the Web3 asset;
retrieving the data of the Web3 asset from the determined location in the blob store; and
presenting the data and the metadata of the Web3 asset to the user.

11. The method according to claim 9, further comprising:
receiving an instruction from the user at the Web server to transfer the Web3 asset to a second identifier; and
in response to the instruction:
storing the second identifier in the database table in association with the identifier of the user, the identifier of the Web3 asset and the metadata;
generating a second encrypted operation to transfer the Web3 asset to the second identifier, the second encrypted operation encrypted by the private key associated with the identifier of the tenant; and
transmitting the second encrypted operation to the Web3 database.

12. The method according to claim 8, further comprising:
receiving an instruction from a user at the Web server to transfer the Web3 asset to a second wallet identifier; and
in response to the instruction:
storing the second identifier in the database table in association with the identifier of the Web3 asset and the metadata;
generating a second encrypted operation to transfer the Web3 asset to the second identifier, the second encrypted operation encrypted by the private key associated with the identifier of the tenant; and
transmitting the second encrypted operation to the Web3 database.

13. The method according to claim 8, further comprising:
receiving an instruction at the Web server to assign the Web3 asset to a user; and
in response to the instruction, storing an identifier of the user in the database table in association with the identifier of the Web3 asset, the metadata and the tenant identifier.

14. The method according to claim 13, further comprising:
transmitting from the Web server an e-mail to the user including a link associated with the Web3 asset;
receiving an HTTP request from the user including the link; and
in response to the HTTP request:
retrieving the stored metadata of the Web3 asset based on the link;
retrieving the data of the Web3 asset from the blob store; and
presenting the data and the metadata of the Web3 asset to the user.

15. A non-transitory medium storing program code executable by at least one processing unit of a computing system to cause the computing system to:
receive a request at a Web server to create a Web3 asset on a Web3 database, the request identifying metadata and data associated with the Web3 asset; and
in response to the received request:
store an identifier of the Web3 asset in a database table in association with the metadata and an identifier of a tenant;
store the data associated with the Web3 asset in a blob store;
generate an encrypted operation to create the Web3 asset on the Web3 database, the encrypted operation encrypted by a private key associated with the identifier of the tenant; and
transmit the encrypted operation to the Web3 database.

16. The medium according to claim 15, the program code executable by at least one processing unit of a computing system to cause the computing system to:
receive a second request from a user at the Web server to claim the Web3 asset; and
in response to the second request, store an identifier of the user in association with the stored identifier of the Web3 asset, metadata and the identifier of the tenant.

17. The medium according to claim 16, the program code executable by at least one processing unit of a computing system to cause the computing system to:
receive a third request from the user at the Web server to view the Web3 asset; and
in response to the third request:
retrieve the stored metadata of the Web3 asset based on the identifier of the Web3 asset;
determine a location of the data of the Web3 asset in the blob store based on the identifier of the Web3 asset;
retrieve the data of the Web3 asset from the determined location in the blob store; and
present the data and the metadata of the Web3 asset to the user.

18. The medium according to claim 16, the program code executable by at least one processing unit of a computing system to cause the computing system to:
receive an instruction from the user at the Web server to transfer the Web3 asset to a second identifier; and
in response to the instruction:
store the second identifier in the database table in association with the identifier of the user, the identifier of the Web3 asset and the metadata;
generate a second encrypted operation to transfer the Web3 asset to the second identifier, the second encrypted operation encrypted by the private key associated with the identifier of the tenant; and
transmit the second encrypted operation to the Web3 database.

19. The medium according to claim 15, the program code executable by at least one processing unit of a computing system to cause the computing system to:
receive an instruction from a user at the Web server to transfer the Web3 asset to a second wallet identifier; and
in response to the instruction:
store the second identifier in the database table in association with the identifier of the Web3 asset and the metadata;
generate a second encrypted operation to transfer the Web3 asset to the second identifier, the second encrypted operation encrypted by the private key associated with the identifier of the tenant; and
transmit the second encrypted operation to the Web3 database.

20. The medium according to claim 15, the program code executable by at least one processing unit of a computing system to cause the computing system to:
receive an instruction at the Web server to assign the Web3 asset to a user;
in response to the instruction, store an identifier of the user in the database table in association with the identifier of the Web3 asset, the metadata and the tenant identifier;
transmit from the Web server an e-mail to the user including a link associated with the Web3 asset;
receive an HTTP request from the user including the link; and
in response to the HTTP request:
retrieve the stored metadata of the Web3 asset based on the link;
retrieve the data of the Web3 asset from the blob store; and
present the data and the metadata of the Web3 asset to the user.
